(19) United States
(12) Patent Application Publication
(10) Pub. No.: US 2025/0382489 A1
(43) Pub. Date: Dec. 18, 2025

(54) INSULATED STEEL PIPE AND ITS METHOD OF MANUFACTURE

(71) Applicant: 2543500 ALBERTA LTD., D.B.A. SHAW PIPE PROTECTION, Calgary (CA)

(72) Inventor: Eileen WAN, Toronto (CA)

(21) Appl. No.: 19/316,826

(22) Filed: Sep. 2, 2025

Related U.S. Application Data
(63) Continuation of application No. PCT/CA2024/050299, filed on Mar. 12, 2024.

(51) Int. Cl. C09D 123/00; B05D 1/08; C09D 5/08

(52) U.S. Cl. CPC C09D 123/00; B05D 1/08; C09D 5/08; B05D 2202/10; B05D 2254/02; B05D 2420/02; B05D 2507/00

(57) ABSTRACT

An insulated pipe segment having a coating overtop of the otherwise exposed insulation layer in the cut-back region. Also, its method of manufacture, comprising spray coating the exposed insulation layer in the cut-back region with a thermoplastic powder, which is wetted. The coating for the exposed insulation layer may be made of a compatible, similar or identical but unfoamed thermoplastic as the insulation layer itself, which is typically foamed.

### RELATED APPLICATION DATA

The present application is a continuation of international PCT patent application no. PCT/CA2024/050299 filed Mar. 12, 2024, which claims priority to, and the benefit of, U.S. provisional patent application No. 63/489,949, filed Mar. 13, 2023, the content of both of these documents being incorporated herein by reference.

### FIELD

The present disclosure is related to a method and apparatus for coating a pipe section, and particularly for manufacturing a pipe section with layers of coating.

### BACKGROUND

Steel pipe sections for use in oil and gas pipeline projects are manufactured in discrete lengths and welded together to form pipeline. The manufacturing of such pipe sections comprises the manufacturing of a steel pipe length, then coating said steel pipe length with various coatings on the outside of the pipe (external coatings) and sometimes on the inside of the pipe (internal coatings), depending on the application. Typically, external coatings are multi-layer laminates, comprising an anti-corrosion coating, which is often an epoxy layer such as a fusion bonded epoxy layer, applied directly to the bare, clean steel, with other coatings overtop of the anti-corrosion coating to provide impact resistance, insulation, and/or weight. For example, the anti-corrosion coating may be coated with a polyethylene or polypropylene topcoat, for impact resistance.

Insulated pipeline is increasingly important. Such pipeline is utilized to allow high temperature transportation of oil in low temperature environments. Polystyrene or styrene-based thermoplastic thermal insulation coatings, and multilayer coatings comprising a polystyrene or styrene-based thermoplastic are described in U.S. Pat. No. 8,714,206, incorporated herein by reference. WO 2014/131127, also incorporated herein by reference, describes a polymeric composition for insulating pipelines comprising a layer of solid or foam insulation comprising a high temperature resistant polysulfone, a polyphenylsulfone, or a polyethersulfone. The insulated high-temperature transport conduit (or pipe) described in that patent application comprises a continuous steel pipe made up of one or more pipe sections, a corrosion protection layer over the outer surface of the steel pipe, and a first thermal insulation layer comprising a polysulfone having a Vicat softening point greater than 200 degrees celcius and a thermal conductivity of less than about 0.40 W/mK. The polysulfone may comprises phenyl groups bridged by sulfone, ether and isopropylidene bridging groups, for example, the polysulfone may comprise a polyphenylsulfone.

Thermal insulation coatings comprising polycarbonate and polycarbonate blends, polyphenylene oxide and polyphenylene oxide blends, polyamides, polymethylpentene and polymethylpentene blends, cyclic olefin copolymers and blends thereof, and partially crosslinked thermoplastic elastomers are described in U.S. Pat. No. 8,397,765, incorporated herein by reference.

Thermal insulation coatings comprising solid or foamed polypropylene homopolymer or copolymer, polybutylene, polyethylene, polystyrene, high impact or modified polystyrene, crosslinked or partially cross-linked polypropylene and polyethylenes, are described in U.S. Pat. No. 10,161,556, incorporated herein by reference.

In certain embodiments, as described in WO 2014/131127, the coated pipe may comprise a second thermal insulation layer provided over the polysulfone layer, where the second thermal insulation layer is a thermoplastic in the form of a solid, a blown foam, or a syntactic foam, selected from polypropylene, polybutylene, polyethylene, polystyrene and copolymers, blends and elastomers thereof, where the polystyrene may comprise high impact polystyrene.

In many cases, the thermal insulation coating or layer is a foamed thermoplastic (the terms “thermal insulation coating” and “thermal insulation layer” are used interchangeably in this specification). Foaming may be accomplished by means of incorporating gas or gas-filled (hollow) fillers (“blown” and “syntactic” foam, respectively). Though foamed thermoplastics allow for increased thermal insulation properties (as compared to their non-foamed, or solid, counterparts), they have many disadvantages as well, due to the structure and density of the foam. These disadvantages can include decreased impermeability to moisture, decreased impact resistance, decreased rigidity, and decreased structural strength. In general, for the same thermoplastic, the more gas or hollow fillers in the foam, the greater the insulative properties, and the greater the disadvantages in terms of increased moisture permeation, decreased impact resistance, and decreased rigidity and structural strength.

Many if not most or all insulated pipe sections comprise a laminate that includes at least an anti-corrosion coating such as a fusion-bonded epoxy layer applied immediately to the exterior of the steel pipe; optionally a topcoat layer such as a polyethylene or polypropylene layer overtop of the anti-corrosion coating (which may in some cases be considered or referred to as part of the anti-corrosion coating); a thermal insulation layer, which is typically a foamed thermoplastic as previously described; and an outer jacket, which is an outer coating, often polyethylene or polypropylene based, which confers moisture resistance (which is typically impervious to moisture at operating temperatures) and/or impact resistance. In some embodiments, any of these layers (the anti-corrosion layer, the thermal insulation layer, and the outer jacket) may itself be a multilaminate with each layer of the multilaminate having subtly or drastically different properties.

Insulated pipe sections are manufactured in a factory environment, then shipped to the field (or to a ship) for manufacturing of pipeline. The pipeline is manufactured by placing these insulated pipe sections end to end and welding the steel sections together to form a conduit.

To facilitate such welding of steel sections together, the coating ends are cut-back from the pipe ends, typically in a bevel or chamfer, to minimize residual stresses at the ends of the coating and also to expose bare steel to allow for subsequent pipeline assembly, including welding of the steel sections and field jointing.

This “cut-back” process is typically also performed in the factory environment.

While the majority of the insulated coating is protected by a generally impervious outer jacket, cutting back the coatings from the pipeline section ends has the effect of exposing inner layers of laminate, including the insulation layer, to the environment at the pipe ends. The exposed portion of the insulation layer is at risk of absorbing moisture from environmental exposure, which can result in both degradation of the insulation layer integrity, as well as manufacturing difficulties when installing field joint coatings.

Several methods have been utilized to attempt to avoid such moisture exposure to the exposed sections of insulation layer. Plastic bags have been used to wrap the pipe ends; however, these are easily punctured, and difficult to seal. To compound the problem, moisture which is allowed to enter becomes pooled within the bags, creating a highly humid environment thus exacerbating moisture uptake. End seal tape has also been developed, which is a PVC tape with pressure sensitive adhesive, however, this is difficult to install without wrinkles, which act as pathways for moisture ingress. In addition, polymers used in the end seal tape become permeable to moisture at temperatures in the upper range of possible storage conditions. The end seal tape must also typically be removed during the field jointing process, creating an extra step and added waste.

It would be desirable to protect the exposed ends of the insulation coating of an insulated pipe section in an improved manner. Ideally, such protection could remain in place as a field joint is applied, with minimal effect on the adherence of the field joint, the insulation properties of the insulation layer, and/or on the other performance characteristics of the pipeline.

### SUMMARY OF THE INVENTION

According to one aspect of the present invention is provided a multilayer coated pipe segment, comprising: a steel pipe having two ends, an interior surface, and an exterior surface, said steel pipe having a coated region and one or two cut-back region, each of said cut-back region at one of said two ends; a first layer of coating overtop of the exterior surface of the steel pipe, coating the coated region and a portion or all of said cut-back region, said first layer being an anti-corrosion coating; a second layer of coating overtop of the anti-corrosion coating, coating the coated region and a portion of said cut-back region, said second layer being an insulation layer; a third layer of coating overtop of the insulation coating, coating the coated region, said third layer being an outer jacket coating; wherein a portion of the insulation layer in the cut-back region is exposed in that it is not coated by the outer jacket coating; further comprising an insulation end coating, coating the exposed portion of the insulation layer.

According to certain embodiments, the multilayer coated pipe segment further comprises at least one additional layer of coating between the first layer and the second layer, and/or between the second layer and the third layer.

According to certain embodiments, the insulation layer comprises a foamed polyolefin.

According to certain embodiments, the foamed polyolefin is a blown foam polyolefin.

According to certain embodiments, the foamed polyolefin is a syntactic foam polyolefin.

According to certain embodiments, the insulation layer comprises a foamed polystyrene or a foamed polypropylene.

According to certain embodiments, the insulation end coating comprises a non-foamed polyolefin with the same or compatible constituent polymers as the insulation layer.

According to certain embodiments, the insulation end coating is melt-bonded to the coating.

According to certain embodiments, the exposed portion of the insulation coating is one or more of chamfered, beveled, stepped, and multistepped.

According to certain embodiments, the insulation end coating overcoats the third layer and/or the first layer within the cutback region.

According to certain embodiments, the insulation end coating is of a thickness which provides moisture resistance.

According to certain embodiments, the insulation end coating is of a thickness which provides impact resistance.

A further aspect of the present invention is a process for manufacturing a multi layer coated steel pipe segment, comprising: coating a steel pipe with an anti-corrosion coating to form an anti-corrosion layer; applying an insulation coating overtop of the anti-corrosion layer to form an insulation layer; applying a topcoat overtop of the insulation layer to form a top coat layer; removing a portion of the topcoat layer and a portion of the insulation layer from the ends of the pipe segment to form a cut-back region having a portion of the insulation layer being exposed, in that said exposed region is not coated in top coat layer; and applying an insulation end coating overtop of the exposed insulation layer.

According to certain embodiments, the process comprises applying at least one additional layer of coating between the anti-corrosion layer and the insulation layer and/or between the insulation layer and the top coat layer.

According to certain embodiments, the insulation layer comprises a foamed polyolefin.

According to certain embodiments, the foamed polyolefin is a blown foam polyolefin.

According to certain embodiments, the foamed polyolefin is a syntactic foam polyolefin.

According to certain embodiments, the insulation layer comprises a foamed polystyrene or a foamed polypropylene.

According to certain embodiments, the insulation end coating is a non-foamed polyolefin having the same or compatible constituent polymers as the insulation layer.

According to certain embodiments, the exposed portion of the insulation coating is one or more of chamfered, beveled, stepped, and multi-stepped.

According to certain embodiments, the insulation end coating application also overcoats the anti-corrosion coating and/or the topcoat within the cutback region.

According to certain embodiments, the insulation end coating is applied to a thickness which provides moisture resistance.

According to certain embodiments, the insulation end coating is applied to a thickness which provides impact resistance.

According to certain embodiments, the insulation end coating is applied as a thermal spray-applied thermoplastic powder which is wetted out and melted.

According to certain embodiments, the thermal spray-applied thermoplastic powder is wetted out utilizing a thermal source, for example, flame spray, hot air, radiant heat, or a laser.

### BRIEF DESCRIPTION OF THE DRAWINGS

FIG. 1 shows a prior art pipe segment in schematic form in FIG. 1.

FIG. 2 shows a prior art pipe segment in cross-section.

FIG. 3 shows pipeline manufacturing.

FIG. 4 shows an embodiment of the present invention.

FIG. 5 shows an embodiment of the present invention with overcoating.

FIG. 6 shows an embodiment of the present invention with overcoating.

### DETAILED DESCRIPTION

It has been found that coating the exposed areas of the insulation layer in the cut-back region of a pipe segment improves the integrity of the cut-back region and of the pipe segment, particularly the insulation layer of the pipe segment. Further, coating said exposed area of the insulation layer can prevent moisture ingress into the insulation layer during storage or transport, prior to field jointing, which improves the integrity of the insulation layer as a whole. Coating the exposed area of the insulation layer in the cut-back region may also confer structural strength which is helpful in maintaining the shape and properties of the insulation layer during transport.

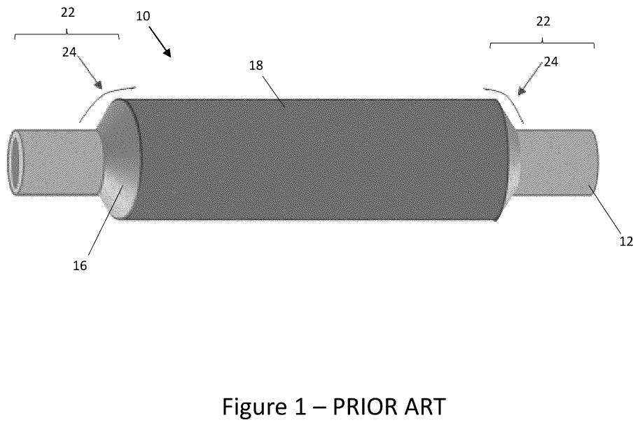

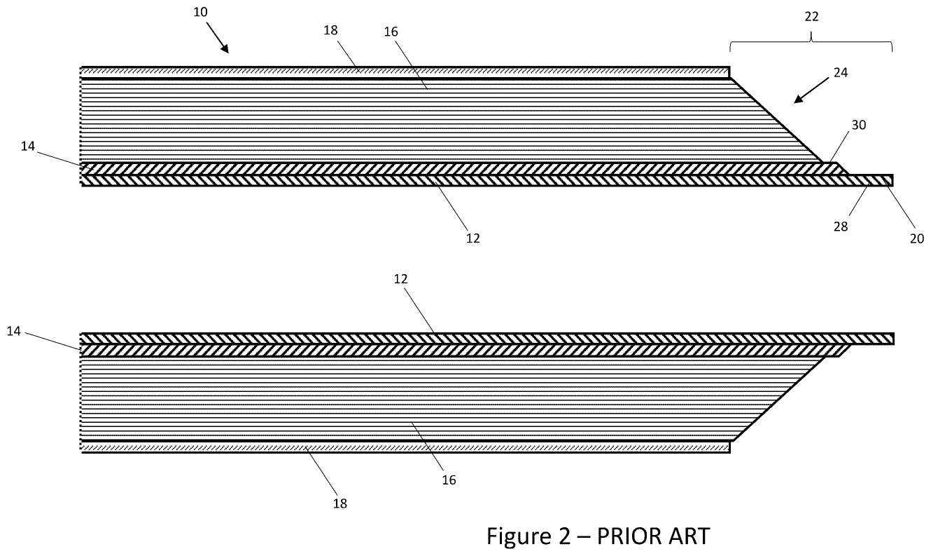

A prior art pipe segment is shown in schematic form in FIG. 1, and in cross-section in FIG. 2. Pipe segment 10 comprises a steel pipe 12 with one or multiple layers of coating. Steel pipe 12 may be internally coated (not shown). Steel pipe 12 is typically coated with an anti-corrosion coating 14, which is typically a fusion-bonded epoxy coating, which adheres strongly to the bare, clean steel pipe 12 and provides excellent anti-corrosion properties. Anti-corrosion coating 14 may itself be coated with a top coat (not shown), which provides structural strength, impact resistance, and/or moisture resistance. The top coat (not shown) may be a layer of polyethylene or polypropylene, for example. Note that in some prior art nomenclatures, the fusion bonded epoxy coating (shown as anti-corrosion coating 14) and the top coat (not shown) may be together identified as an anti-corrosion coating. The anti-corrosion coating 14 (or, in exemplifications where there is a top coat, the top coat) is coated in an insulation layer 16. The insulation layer 16 may be made from a wide variety of materials, typically a foamed polymer or polymer blend. The insulation layer 16 is typically less dense, and more porous than the anti-corrosion coating 14, and is typically more permeable to moisture, and less resistant to impact damage. Accordingly, insulation layer 16 is typically covered in an outer jacket 18, which is a moisture and impact resistant layer meant to be relatively impervious to the elements.

Note that the proportions of the various layers of the pipe are not shown to scale, or in relation to one another; for example, the anti-corrosion coating 14 may be only a few millimeters thick whereas the steel pipe 12 may be more than an inch thick. As well, the length of the pipe segment 10 is not shown to scale in FIG. 1, since pipe segment 10 may be manufactured in different lengths, and is typically 25 or 50 feet in length.

As shown for simplicity's sake, each of anti-corrosion coating 14, insulation layer 16, and outer jacket 18 are a single layer, but it would be appreciated that each may in fact be a multi-layer laminate, and such pipe segments are readily and commonly known in the art.

Pipe segment 10 may also have other layers, such as weight coatings (such as a concrete layer), etc.

FIG. 2 shows a cutaway, mid-line cross-sectional view of an end of pipe segment 10. Only the right end of the pipe segment 10 is shown, with dotted lines on the left side of the pipe segment 10 depicting a cutaway. It would be appreciated that the left end of the pipe segment 10 would be a generally mirror image of the right end of the pipe segment 10 which is shown. Depicted is the pipe end 20, and the cut-back region 22 of the pipe segment. Typically, the various layers of coating do not continue to the pipe end 20, but a section of exposed steel 28 is left uncoated at the pipe end 20. This is because the pipe ends of pipe segments are connected, end to end, to form a pipeline. Accordingly, to manufacture a pipeline, the steel pipe end 20 is welded to the end of the pipeline in order to extend the pipeline by the length of the pipe segment 10. As such, the steel pipe end 20 is exposed so that it can be welded. Cut-back region 22 is shown, where the various coatings have been “cut back” in order to provide access to the steel pipe end 20. As shown, the various sections of coating in the cut-back region 22 are beveled, or chamfered. There may be one or more steps 30 between or within any layer of coating, of various lengths and at various depths, or the beveling/chamfering can be continuous.

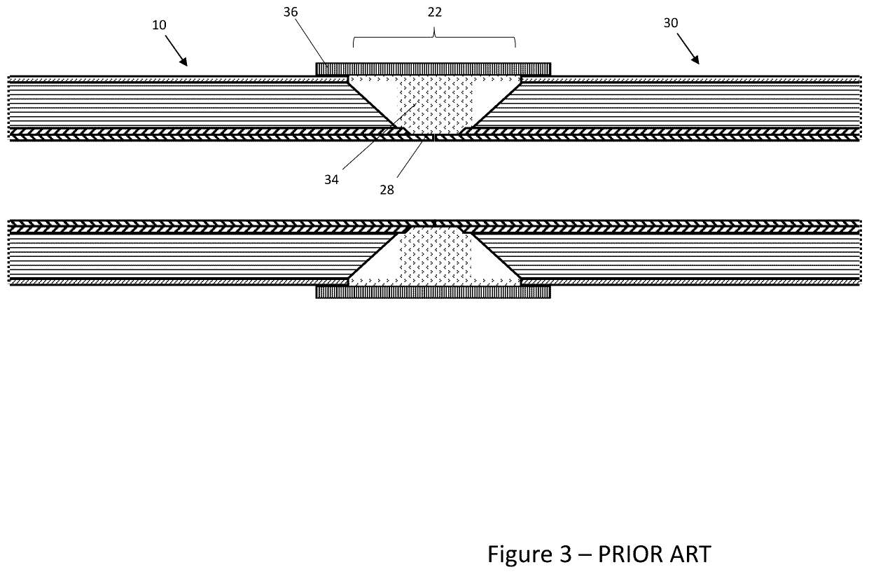

Pipeline manufacturing (FIG. 3) comprises welding steel pipe end 20 to the end of the pipeline 30, then providing a field coating for the cut-back region 22. Field coating typically comprises applying an anti-corrosion layer (not shown) onto the section of exposed steel 28, applying a shrink sleeve or wrap 36 with impact and moisture resistant properties, and/or filling the cut-back region 22 with a cut-back insulation 34 with insulative properties similar to, but typically lower, than those of the insulation layer 16.

Because the exposed insulation end 24 is exposed to the environment during transport and storage, there is potential for moisture ingress, as well as impact damage, both of which may affect both the integrity of the insulation layer 16 as well as the field coating process. For example, a moist or uneven exposed insulation end 24 may create problems with adherence of the field coating, or the insulative properties near or in the field coating area. A moist or uneven exposed insulation end 24 may need to be grinded down or otherwise removed so that dry insulation is exposed, disadvantageously increasing the size of the cut-back region and adding a costly and time consuming step.

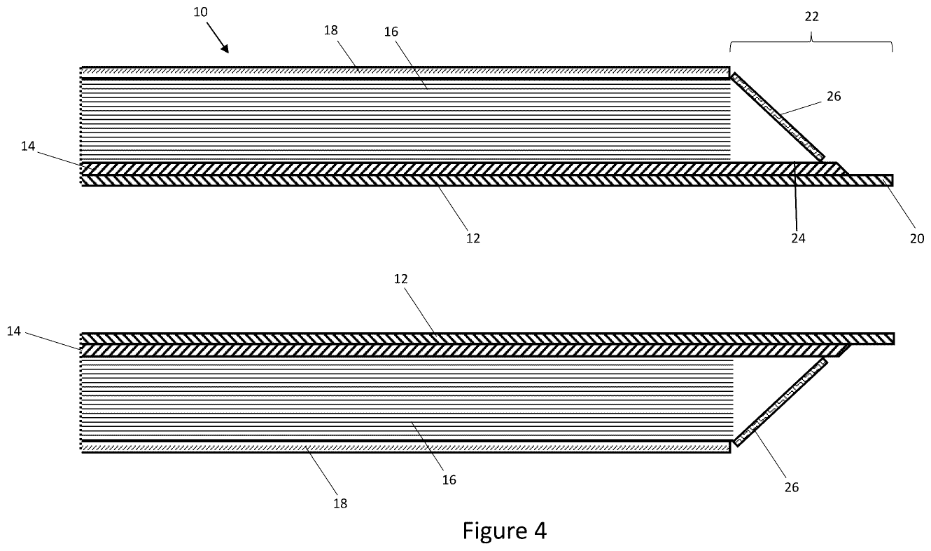

FIG. 4 shows an embodiment of the present invention. During the manufacture of the pipe segment 10, the exposed insulation end 24 is coated with an insulation end coating 26, sealing the exposed insulation end 24 and providing a barrier similar in moisture-resistant property to the outer jacket 18. The exposed insulation end 24 is sealed utilizing a thermal spray-applied thermoplastic powder which forms the insulation end coating 26. The powder is wetted out and melted to the exposed insulation end 24 to a preferred thickness, providing a barrier to moisture. The thermal spray-applied thermoplastic powder can be wetted out by any thermal source, including flame spray, hot air, or laser.

In preferred embodiments, the thermal spray applied thermoplastic powder is of compatible, similar or identical thermoplastic chemistry to the insulation layer 16, allowing for bonding. Thus, in many instances, the insulation layer 16 is a foamed thermoplastic, and the exposed insulation end 24 of the (foamed) insulation layer 16 is coated by a thermoplastic powder of compatible, identical or near identical constituents, but in an “un-foamed” form. By utilizing powder of compatible, similar or identical chemistry to the insulation layer 16, the bonding to the exposed insulation end 24 is excellent. Also, by utilizing powder of similar or identical chemistry to the insulation layer 16, conventional field coatings that are designed for bonding to the exposed insulation end 24 will bond in an excellent, if not equivalent manner, to the insulation end coating 26. Therefore, in preferred embodiments, the insulation end coating 26 can be left in place when installing a field coating. However, alternatively, if desired, the insulation end coating 26 can be removed from the exposed insulation end 24 shortly before applying the field joint (either before, or after, welding the pipe segment to the pipeline), for example, by grinding.

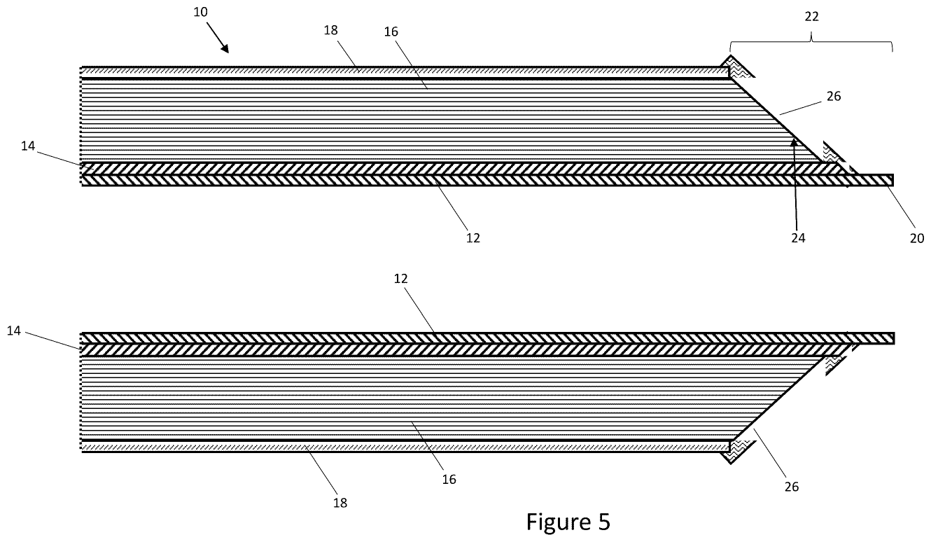

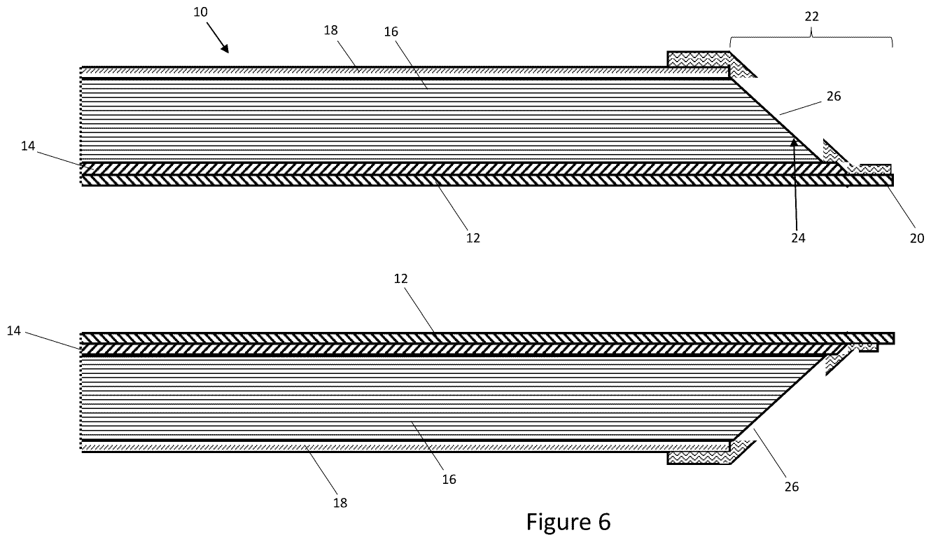

In a preferred embodiment, and as shown in FIG. 4, the insulation end coating 26 covers the entire exposed insulation end 24 of the insulation layer 16. However, in alternative embodiments, it may be preferable or at least acceptable to “overcoat” other layers, as shown in FIGS. 5 and 6. FIG. 5 shows insulation end coating 26 which covers the entire exposed insulation end 24 of the insulation layer 16, but also overcoats other coatings, as shown the outer jacket 18 and the anti-corrosion coating 14. FIG. 6 shows a similar configuration, with even more overlap with the outer surface of the outer jacket 18. As can be appreciated, in alternative embodiments (not shown) only the anti-corrosion coating 14 layer is overcoated, and not the outer jacket 18, or vice versa.

### PARTS LIST

10—pipe segment
12—steel pipe
14—anti-corrosion coating
16—insulation layer
18—outer jacket
20—pipe end
22—cutback region
24—exposed insulation end
26—insulation end coating
28—section of exposed steel
30—steps
32—pipeline

1. A multilayer coated pipe segment, comprising:
a. a steel pipe having two ends, an interior surface, and an exterior surface, said steel pipe having a coated region and one or two cut-back region, each of said cut-back region at one of said two ends;
b. a first layer of coating overtop of the exterior surface of the steel pipe, coating the coated region and a portion or all of said cut-back region, said first layer being an anti-corrosion coating;
c. a second layer of coating overtop of the anti-corrosion coating, coating the coated region and a portion of said cut-back region, said second layer being an insulation layer;
d. a third layer of coating overtop of the insulation coating, coating the coated region, said third layer being an outer jacket coating;
wherein a portion of the insulation layer in the cut-back region is exposed in that it is not coated by the outer jacket coating;
further comprising an insulation end coating, coating the exposed portion of the insulation layer.

2. The multilayer coated pipe segment of claim 1, further comprising at least one additional layer of coating between the first layer and the second layer, and/or between the second layer and the third layer.

3. The multilayer coated pipe segment of claim 1, wherein the insulation layer comprises a foamed polyolefin.

4. The multilayer coated pipe section of claim 3, wherein the foamed polyolefin is a blown foam polyolefin.

5. The multilayer coated pipe section of claim 3, wherein the foamed polyolefin is a syntactic foam polyolefin.

6. The multilayer coated pipe segment of claim 3 wherein the insulation layer comprises a foamed polystyrene or a foamed polypropylene.

7. The multilayer coated pipe segment of claim 3 wherein the insulation end coating comprises a non-foamed polyolefin with the same or compatible constituent polymers as the insulation layer.

8. The multilayer coated pipe segment of claim 1 wherein the insulation end coating is melt-bonded to the coating.

9. The multilayer coated pipe segment of claim 1 wherein the exposed portion of the insulation coating is one or more of chamfered, beveled, stepped and multistepped.

10. The multilayer coated pipe segment of claim 1 wherein the insulation end coating overcoats the third layer and/or the first layer within the cutback region.

11. The multilayer coated pipe segment of claim 1 wherein the insulation end coating is of a thickness which provides moisture resistance.

12. The multilayer coated pipe segment of claim 1 wherein the insulation end coating is of a thickness which provides impact resistance.

13. A process for manufacturing a multilayer coated steel pipe segment, comprising:
a. coating a steel pipe with an anti-corrosion coating to form an anti-corrosion layer;
b. applying an insulation coating overtop of the anti-corrosion layer to form an insulation layer;
c. applying a topcoat overtop of the insulation layer to form a top coat layer;
d. removing a portion of the topcoat layer and a portion of the insulation layer from the ends of the pipe segment to form a cut-back region having a portion of the insulation layer being exposed, in that said exposed region is not coated in top coat layer; and
e. applying an insulation end coating overtop of the exposed insulation layer.

14. The process of claim 13 further comprising applying at least one additional layer of coating between the anti-corrosion layer and the insulation layer and/or between the insulation layer and the top coat layer.

15. The process of claim 13 wherein the insulation layer comprises a foamed polyolefin.

16. The process of claim 15 wherein the foamed polyolefin is a blown foam polyolefin.

17. The process of claim 15 wherein the foamed polyolefin is a syntactic foam polyolefin.

18. The process of claim 15 wherein the insulation layer comprises a foamed polystyrene or a foamed polypropylene.

19. The process of claim 15 wherein the insulation end coating is a non-foamed polyolefin having the same or compatible constituent polymers as the insulation layer.

20. The process of claim 13 wherein the exposed portion of the insulation coating is one or more of chamfered, beveled, stepped, and multi-stepped.

21. The process of claim 13 wherein the insulation end coating application also overcoats the anti-corrosion coating and/or the topcoat within the cutback region.

22. The process of claim 13 wherein the insulation end coating is applied to a thickness which provides moisture resistance.

23. The process of claim 13 wherein the insulation end coating is applied to a thickness which provides impact resistance.

24. The process of claim 13 wherein the insulation end coating is applied as a thermal spray—applied thermoplastic powder which is wetted out and melted.

25. The process of claim 24 wherein the thermal spray-applied thermoplastic powder is wetted out utilizing a thermal source, for example, flame spray, hot air, radiant heat, or a laser.
